(19) United States
(12) Patent Application Publication
(10) Pub. No.: US 2004/0031176 A1
(43) Pub. Date: Feb. 19, 2004

(54) Three-dimensional article of manufacture presenting a near-normal view from a wide range of perspectives

(76) Inventor: Moustapha MBacke, Indianapolis, IN (US)

Correspondence Address: Gregory P. Gadson, Esq., 19375 Amber Way, Noblesville, IN, 46060, US

(21) Appl. No.: 10/219,970

(22) Filed: Aug. 15, 2002

(51) Int. Cl. G09F 19/14

(52) U.S. Cl. 40/453

(57) ABSTRACT

A novel three-dimensional article of manufacture provides a viewer with a three-dimensional, statue-like view, including being able to see details from both hemispheres of a statue when viewed off-normal. The article of manufacture at least includes a background region and a statue image region. The statue image region is an inverted view of a view of a three-dimensional statue (i.e., a concave outline when viewed from a positive plane). In a preferred embodiment, the statue image region depicts an interpretation of the face of a religious icon, and the effect produced by the novel configuration is that of a normal (i.e., frontal) view being produced even though a viewer's vantage point is lateral to the horizontal normal plane, or azimuthal to the vertical plane.

### BACKGROUND OF THE INVENTION

1. Field of the Invention

The present invention generally relates to improvements in the design and manufacture of statuettes, statues, and other three-dimensional articles of manufacture depicting the faces of humanoid or animal beings.

2. Background

Statues, statuettes, and similar articles of manufacture have always served important social, religious, political, entertainment and other purposes. One of the important differences in the aforementioned articles of manufacture and flat images is the three-dimensional effect experienced by a viewer because of the constant, yet very small, rapid shifting motion of eyes in humans that results in the mind integrating many marginally different views to produce depth perception.

One of the important considerations addressed by the present invention is the desire to produce three-dimensional views from articles of manufactures that remain relatively constant when a viewer changes his or her position. For example, a religious icon that seems to follow the viewer would be of great interest (e.g., “Jesus is watching over you,” or the like, as this approach would not be limited to any particular faith). Prior art simple statues and statuettes are not capable of producing this effect, since an off-center view always obscures details from the far-side hemisphere. A complicated and expensive approach that may also be unreliable, is to include a means for tracking the movement of a viewer, and then automatically rotating (i.e., by motor) the statue so that the viewer always sees a normal view. “Normal” refers to an exact anterior (or exact posterior) view, where the viewer is positioned perpendicular to the imaginary plane separating the anterior and posterior portions of the statue. Even if this cumbersome approach could work, it provides normal views only for viewers with the same lateral (or even vertical) position, but not others.

Another approach would be to construct one or more paneled images with refractory layers, so that two or three images are produced when the viewer changes his or her position. Not only does this approach fail to produce three-dimensional images, but the movement of the images is discontinuous, “jumpy,” and far too few normal or near-normal views are produced. In addition, this approach is more suitable for the novelty items that may be found as prizes in cereal boxes, and is not dignified enough for serious pursuits.

Other current or potential prior art approaches also fail to produce normal views from an article of manufacture that shift with a viewer's changing position. For example, holography can be used to produce interfering light waves that give the illusion of depth. However, not only is this approach extremely expensive, but it does not automatically produce normal views from a variety of viewer vantage points.

### SUMMARY OF THE INVENTION

In view of the aforementioned problems and deficiencies of the prior art, the present invention provides a three-dimensional article of manufacture that at least includes a background region, and a statue image region embedded in the background region. The statue image region at least includes an outline of a statue image which is the inversion of a conventional three-dimensional statue with respect to a viewer in a positive plane relative to the background region, the image outline at least containing concavity with respect to the positive plane, and at least one sub-image region on each hemisphere of the statue image region. The article of manufacture is adapted to give an illusion that a near-normal view is produced when viewed away from a normal plane, so that sub-image regions from both hemispheres are visible when viewed away from the normal plane.

### BRIEF DESCRIPTION OF THE DRAWING FIGURES

Features and advantages of the present invention will become apparent to those skilled in the art from the description below, with reference to the following drawing figures, in which:

FIG. 1 is a top view of a prior art article of manufacture containing a partial statuette;

FIG. 2 is a top view of an article of manufacture containing a partial statuette constructed according to the present invention, whereby the prior art statuette is inverted;

FIG. 3 is a top view of an alternate embodiment of the present-inventive article of manufacture of FIG. 2, having the overall outline of the statuette inverted, but not certain facial features; and

FIG. 4 is a front view of the article of manufacture in FIG. 2.

### DESCRIPTION OF THE PREFERRED EMBODIMENTS

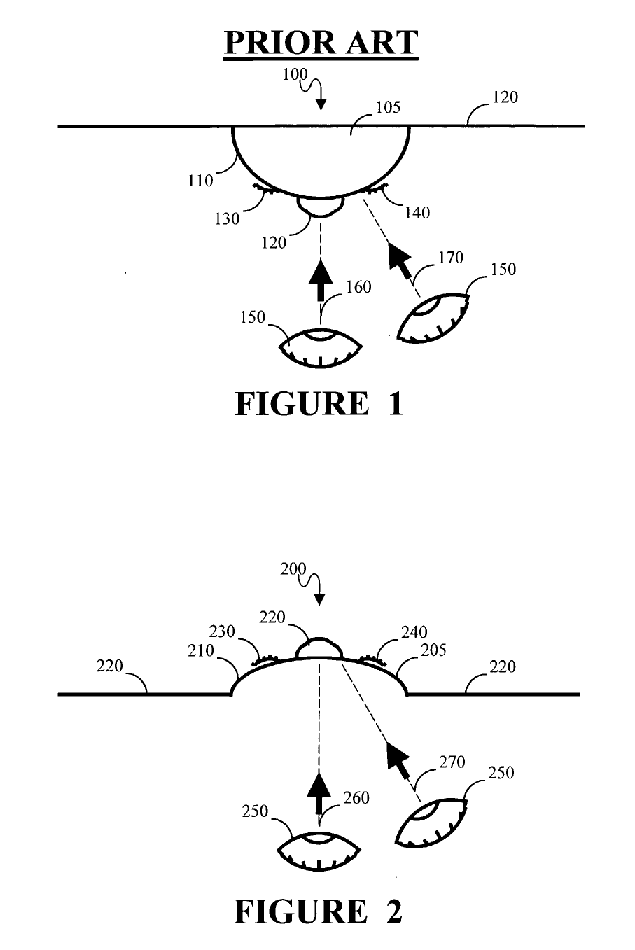

The top view of a prior art article of manufacture 100 is shown in FIG. 1. The prior art article of manufacture 100 has a statue or statue image region 105 against a background region 120. The number 110 generically represents the cranial outline of the statue. For illustrative purposes, the statue region 105 has sub-statue regions 120, 130 and 140, which contain a nose, and two eyes, respectively.

The imaginary line 160 represents the normal (which is perpendicular to the article of manufacture 100), from which a viewer represented by the eye icon 150 can view the article of manufacture 100 directly from the front. The view from the normal 160 might be deemed a “normal” view, where “normal” simply reflects viewing along the normal line, rather than a qualitative description. The normal 160 also divides the statue 105 into two hemispheres.

When the viewer 150 moves off-normal and views the statue region 105 from a position represented by the line 170, he or she is able to see details in the near hemisphere, but may see little or no portions from the far hemisphere, such as the eye 130 and the side of the nose 120 proximate the eye 130.

The preferred embodiment for the present-inventive article of manufacture 200 is illustrated in FIG. 2. The last two digits of the element numbers in FIG. 2 correspond to similar elements in FIG. 1. As can be seen, the present invention novelly inverts (compared with the prior art approach) the statue image 205 so that the cranial/facial outline 210 is concave relative to the viewer 250. As a result, a viewer viewing the statue region 205 off-normal (e.g., along the line 270) is still able to see details from both hemispheres of the article of manufacture 200. Consequently, the present-inventive article of manufacture 200 allows the viewer to perceive an approximation of a normal view even though he or she is removed from the normal position. Employing the teachings of the present invention, an article of manufacture with a statue image can give the optical illusion that the statue pivots as the viewer moves laterally, and that the statue continues to “watch” the viewer.

A frontal view of the present-inventive article of manufacture 200 is presented in FIG. 4. In this particular embodiment, the statue image region 105 contains an artist's interpretation of a religious icon (e.g., “Jesus of Nazareth”) against the background 220 of mountains on top of a ship 480. An addition feature of the configuration in FIG. 4 is a light source 490 for illuminating the article of manufacture for spectacular effect.

Using the novel teachings of the present invention, it is also possible adjust or distort the outline 210 to include more or less radius of curvature than would a conventional statue. An increase in the general radius of curvature would likely be accompanied by an increase in the lateral range within which an approximate normal view can be perceived, while introducing more distortion to the image. Given the teachings of the present invention, the balance between the lateral range (for which approximate normal views can be seen) and distortion is a matter of design choice. It should be noted that excellent lateral range can generally be achieved with de minimis effective distortion.

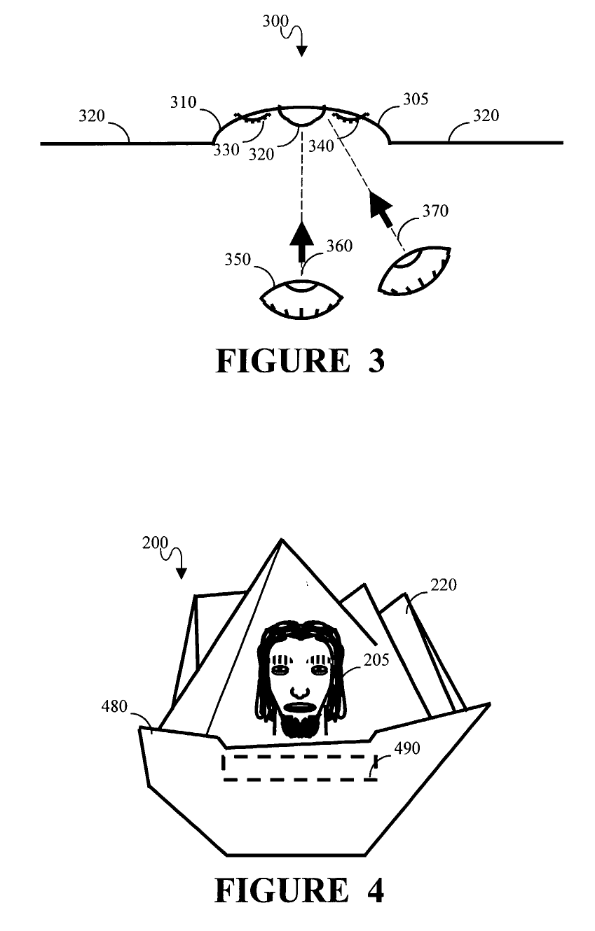

An alternate embodiment 300 is presented in FIG. 3. While the general outline of the statue region is inverted (from what is typical in the prior art), smaller facial features such as the eyes 330, 340 and the nose 320 are not inverted. This combination gives the novel optical pivoting effect when the viewer moves off-normal, while providing more striking facial features. The tradeoff, however, can be some loss of detail in the facial features in the far hemisphere when viewed off-normal.

Variations and modifications of the present invention are possible, given the above description. However, all variations and modifications which are obvious to those skilled in the art to which the present invention pertains are considered to be within the scope of the protection granted by this Letters Patent.

For example, the description of the preferred embodiment of the present invention has assumed that the near-normal views will be produced when a viewer changes his or her lateral position. However, an article of manufacture constructed according to the present invention also produces near-normal views when the viewer changes his or her relative vertical position (which may alternately be described as a change in azimuthal position). Thus, the eyes of a religious icon may appear to be looking at a viewer even with relative vertical position changes (e.g., whether the statuette is at normal viewing height, in a lofty position, such as on a high shelf, or located lower than the normal viewing height).

Also, the imaginary “hemispheres” used to describe the effect of the present invention need not be symmetrical (as is the case for vertical hemispheres when the statue image region contains a normally oriented head).

What is claimed is:

1. A three-dimensional article of manufacture comprising:
a background region; and
a statue image region embedded in said background region;
said statue image region comprising:
an outline of a statue image which is the inversion of a conventional three-dimensional statue with respect to a viewer in a positive plane relative to said background region, said image outline at least containing concavity with respect to said positive plane; and
at least one sub-image region on each hemisphere of said statue image region, wherein said article of manufacture is adapted to give an illusion that a near-normal view is produced when viewed away from a normal plane, so that sub-image regions from both hemispheres are visible when viewed away from said normal plane.

2. The article of manufacture of claim 1, wherein at least one sub-image region from each hemisphere comprises a facial feature.

3. The article of manufacture of claim 1, wherein said statue image region comprises the complete inversion of a view of a three-dimensional statue.

4. The article of manufacture of claim 1, wherein said statue image region comprises the inversion of a view of a three-dimensional statue, and the outline of said statue image region comprises exaggerated curvature compared to that of said three-dimensional statue.

5. The article of manufacture of claim 1, wherein said statue image region comprises the inversion of a view of a three-dimensional statue, and the outline of said statue image region comprises gentler curvature compared to that of said three-dimensional statue.

6. The article of manufacture of claim 2, wherein the outline of said statue image is inverted, but at least one of said facial features is not.

7. The article of manufacture of claim 1, wherein said statue image region depicts an interpretation of the face of a religious icon.

8. The article of manufacture of claim 2, wherein said statue image region comprises at least one eye, and said article of manufacture is adapted to give the illusion that the eyes follow the viewer with lateral changes in the viewer's vantage point.

9. The article of manufacture of claim 6, wherein said statue image region comprises at least one eye, and said article of manufacture is adapted to give the illusion that the eyes follow the viewer with lateral changes in the viewer's vantage point.

10. The article of manufacture of claim 7, wherein said statue image region comprises at least one eye, and said article of manufacture is adapted to give the illusion that the eyes follow the viewer with lateral changes in the viewer's vantage point.

11. The article of manufacture of claim 2, wherein said statue image region comprises at least one eye, and said article of manufacture is adapted to give the illusion that the eyes follow the viewer with azimuthal changes in the viewer's vantage point.

12. The article of manufacture of claim 6, wherein said statue image region comprises at least one eye, and said article of manufacture is adapted to give the illusion that the eyes follow the viewer with azimuthal changes in the viewer's vantage point.

13. The article of manufacture of claim 7, wherein said statue image region comprises at least one eye, and said article of manufacture is adapted to give the illusion that the eyes follow the viewer with azimuthal changes in the viewer's vantage point.

14. The article of manufacture of claim 1, further comprising:
further comprising a lighting apparatus coupled to said background region, said lighting apparatus adapted to illuminate said statue image region with light.

15. The article of manufacture of claim 7, further comprising:
further comprising a lighting apparatus coupled to said background region, said lighting apparatus adapted to illuminate said statue image region with light.

16. The article of manufacture of claim 14, wherein said lighting apparatus is integrated into said background region.

17. The article of manufacture of claim 15, wherein said lighting apparatus is integrated into said background region.

18. The article of manufacture of claim 1, wherein said background region is ornate.

19. The article of manufacture of claim 1, wherein said normal plane divides said statue image region into horizontal hemispheres.

20. The article of manufacture of claim 1, wherein said normal plane divides said statue image region into vertical hemispheres.
